(19) United States
(12) Patent Application Publication
(10) Pub. No.: US 2026/0349945 A1
(43) Pub. Date: Nov. 5, 2026

(54) DIFFERENTIAL ENCODER AND DECODER CIRCUITS FOR HIGH BANDWIDTH MEMORY ACCESS

(71) Applicant: Sandisk Technologies, Inc., Milpitas, CA (US)

(72) Inventors: Sajal Mittal, Bengaluru (IN); Yogesh Pal, Rajasthan (IN); Shiv Harit Mathur, Bengaluru (IN); Suprateek Shukla, Uttar Pradesh (IN)

(73) Assignee: Sandisk Technologies, Inc., Milpitas, CA (US)

(21) Appl. No.: 19/198,166

(22) Filed: May 5, 2025

(51) Int. Cl. G06F 13/36

(52) U.S. Cl. CPC G06F 13/36; G06F 2213/40

(57) ABSTRACT

Control circuits are configured to receive a sequence of words, each word represented by a plurality of signals. Each signal has a corresponding signal level that indicates a corresponding logic state. The control circuits are configured to compare signal levels of a current word in the sequence with signal levels of the previous in the sequence and encode the current word to reduce selected transitions between signal levels of the previous word and corresponding signal levels of the current word.

### BACKGROUND

The present technology relates to communication channels used for communication including communication in data storage systems that include nonvolatile memory.

Semiconductor memory is widely used in various electronic devices such as cellular telephones, digital cameras, personal digital assistants, medical electronics, mobile computing devices, non-mobile computing devices and data servers. Semiconductor memory may comprise nonvolatile memory or volatile memory. A nonvolatile memory allows information to be stored and retained even when the nonvolatile memory is not connected to a source of power (e.g., a battery). Examples of nonvolatile memory include flash memory (e.g., NAND-type and NOR-type flash memory), Electrically Erasable Programmable Read-Only Memory (EEPROM), and others.

When a data storage system that includes nonvolatile memory is deployed in or connected to an electronic device (the host), the memory system can be used to store data and read data. Data, such as user data to be stored in a nonvolatile memory or that is read from a nonvolatile memory, may be sent through one or more communication channels. Address information, command information and other information may also be sent via communication channels. A communication channel may be configured for high bandwidth parallel data transfer to enable transfer of large amounts of data (e.g., for Machine Learning or Artificial Intelligence). Providing high bandwidth transfer while also achieving other metrics (e.g., a high Signal to Noise Ratio (SNR) or a low Bit Error Rate (BER) may be challenging).

### BRIEF DESCRIPTION OF THE DRAWINGS

Like-numbered elements refer to common components in the different Figures.

FIG. 1 is a block diagram depicting one embodiment of a storage system.

FIG. 2A is a block diagram of one embodiment of a memory die.

FIG. 2B is a block diagram of an example of an integrated memory assembly.

FIG. 3 shows an example of a portion of a memory structure.

FIG. 4 shows an example of a communication channel between circuits.

FIGS. 5A-B illustrate an example of two-level communication.

FIGS. 6A-B illustrate an example of four-level communication.

FIG. 7AB illustrate signal swing for two-level and four-level communication.

FIGS. 8A-C illustrate signal slew rates for different transitions of four-level communication.

FIG. 9 illustrates an example of encoding to reduce selected transitions.

FIGS. 10A-E illustrate examples of encoding circuits.

FIG. 11 illustrates an example of a method that includes encoding words to reduce the number of selected transitions.

FIG. 12 illustrates signal-level transitions in an m-signal, n-level communication channel.

FIGS. 13A-D illustrate an encoding scheme in an eight-signal four-level communication channel.

FIG. 14 illustrates an example of a method that includes encoding for a four-level communication channel.

FIG. 15 illustrates an example of a method that includes encoding a word so that the number of transitions between highest and lowest signal levels is reduced.

### DETAILED DESCRIPTION

Techniques are disclosed herein to facilitate communication between circuits (e.g., between circuits of a data storage system) via a communication channel. A communication channel may use parallel communication to convey data (e.g., user data, address data, command data and/or other data) between circuits (e.g., circuits on different dies such as between a memory controller die and a memory die in a data storage system). Interface circuits may be provided at either end of such a communication channel. In order to provide high bandwidth communication over such a communication channel, more than two different signal levels (e.g., voltage levels) may be used. For example, data may be represented by four or more signal levels corresponding to two or more bits of data per signal per clock cycle. Some transitions between signal levels may be associated with unwanted effects (e.g., lower SNR, higher BER or other effects). For example, larger transitions (e.g., between highest and lowest signal levels) may be associated with one or more unwanted effects.

In some aspects of the present technology, data may be encoded prior to sending via a communication channel. Encoding may be applied so that signal level transitions that are associated with unwanted effects are reduced in number. For example, an encoding scheme may reduce the number of transitions between the highest and lowest signal levels (including both highest to lowest and lowest to highest). An example of such an encoding scheme for a four-level communication channel (e.g., four-level Pulse Amplitude Modulation (PAM4)) with signal levels 0, 1, 2 and 3 is: encoded signal level=3−unencoded signal level (e.g., 3→0, 2→1, 1→2 and 0→3), which may be selectively applied to words that meet certain criteria. More generally, for an n-level communication channel with signal levels 0, 1, 2 . . . n-1 (e.g., n-level PAM) an example encoding scheme is: encoded signal level=n-1−unencoded signal level (e.g., n-1→0, n-2→1, n-3→2 . . . 0→n-1), selectively applied. In some cases, where the highest signal level (e.g., 3 or n-1) is not present in a word to be encoded, one or more other signal level corresponding to one or more other transition may be selected and occurrence of the other transition may be reduced.

Aspects of the present technology are directed to technical problems associated with high speed communication including low SNR and high BER that may occur in data sent over high bandwidth communication channels. Aspects of the present technology provide technical solutions including encoding schemes that may reduce the number of certain signal level transitions that may be associated with errors.

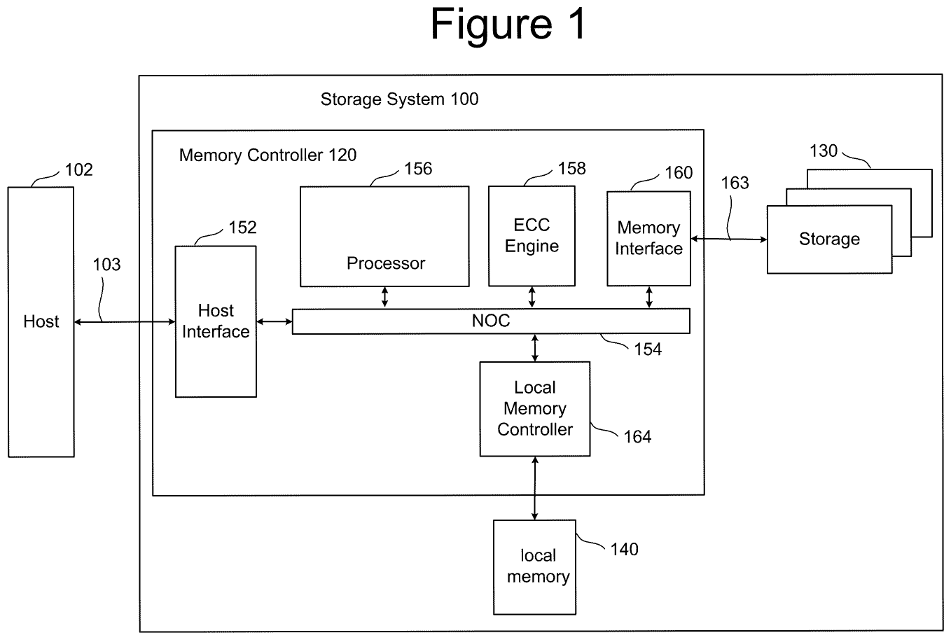

FIG. 1 is a block diagram of one embodiment of a storage system 100 that may be configured to implement aspects of the technology described herein. In one embodiment, storage system 100 is a solid state drive (“SSD”). Storage system 100 can also be a memory card, USB drive or other type of storage system. The proposed technology is not limited to any one type of storage system. Storage system 100 is connected to host 102, which can be a computer, server, electronic device (e.g., smart phone, tablet or other mobile device), appliance, or another apparatus that uses memory and has data processing capabilities. In some embodiments, host 102 is separate from, but connected to, storage system 100. In other embodiments, storage system 100 is embedded within host 102. A communication channel 103 (e.g., parallel communication channel) connects host 102 and storage system 100 to enable communication (e.g., transfer of user data, command data, address data and/or other data) between host 102 and storage system 100

The components of storage system 100 depicted in FIG. 1 are electrical circuits. Storage system 100 includes a memory controller 120 (or storage controller) connected to nonvolatile storage 130 and local high speed memory 140 (e.g., DRAM, SRAM, MRAM). Local memory 140 is non-transitory memory, which may include volatile memory or nonvolatile memory. Local high speed memory 140 is used by memory controller 120 to perform certain operations. For example, local high speed memory 140 may store logical to physical address translation tables (“L2P tables”).

Memory controller 120 comprises a host interface 152 that is connected to and in communication with host 102. In one embodiment, host interface 152 implements an NVM Express (NVMe) over PCI Express (PCIe). Other interfaces can also be used, such as SCSI, SATA, etc. Host interface 152 is also connected to a network-on-chip (NOC) 154. A NOC is a communication subsystem on an integrated circuit. NOC's can span synchronous and asynchronous clock domains or use unclocked asynchronous logic. NOC technology applies networking theory and methods to on-chip communications and brings notable improvements over conventional bus and crossbar interconnections. NOC improves the scalability of systems on a chip (SoC) and the power efficiency of complex SoCs compared to other designs. The wires and the links of the NOC are shared by many signals. A high level of parallelism is achieved because all links in the NOC can operate simultaneously on different data packets. Therefore, as the complexity of integrated subsystems keep growing, a NOC provides enhanced performance (such as throughput) and scalability in comparison with previous communication architectures (e.g., dedicated point-to-point signal wires, shared buses, or segmented buses with bridges). In other embodiments, NOC 154 can be replaced by a bus.

Connected to and in communication with NOC 154 is processor 156, ECC engine 158, memory interface 160, and local memory controller 164. Local memory controller 164 is used to operate and communicate with local high speed memory 140 (e.g., DRAM, SRAM, MRAM).

ECC engine 158 performs error correction services. For example, ECC engine 158 performs data encoding and decoding. In one embodiment, ECC engine 158 is an electrical circuit programmed by software. For example, ECC engine 158 can be a processor that can be programmed. In other embodiments, ECC engine 158 is a custom and dedicated hardware circuit without any software. In another embodiment, the function of ECC engine 158 is implemented by processor 156.

Processor 156 performs the various controller memory operations, such as programming, erasing, reading, and memory management processes. In one embodiment, processor 156 is programmed by firmware. In other embodiments, processor 156 is a custom and dedicated hardware circuit without any software. Processor 156 also implements a translation module, as a software/firmware process or as a dedicated hardware circuit. In many systems, the nonvolatile memory is addressed internally to the storage system using physical addresses associated with the one or more memory die. However, the host system will use logical addresses to address the various memory locations. This enables the host to assign data to consecutive logical addresses, while the storage system is free to store the data as it wishes among the locations of the one or more memory die.

Memory interface 160 communicates with nonvolatile storage 130. In one embodiment, memory interface 160 provides a Toggle Mode interface. Other interfaces can also be used. In some example implementations, memory interface 160 (or another portion of memory controller 120) implements a scheduler and buffer for transmitting data to and receiving data from one or more memory die. Communication channel 163 (e.g., parallel communication channel) connects memory interface 160 with nonvolatile storage 130 to enable communication (e.g., transfer of user data, command data, address data and/or other data) between memory controller 120 and nonvolatile storage 130.

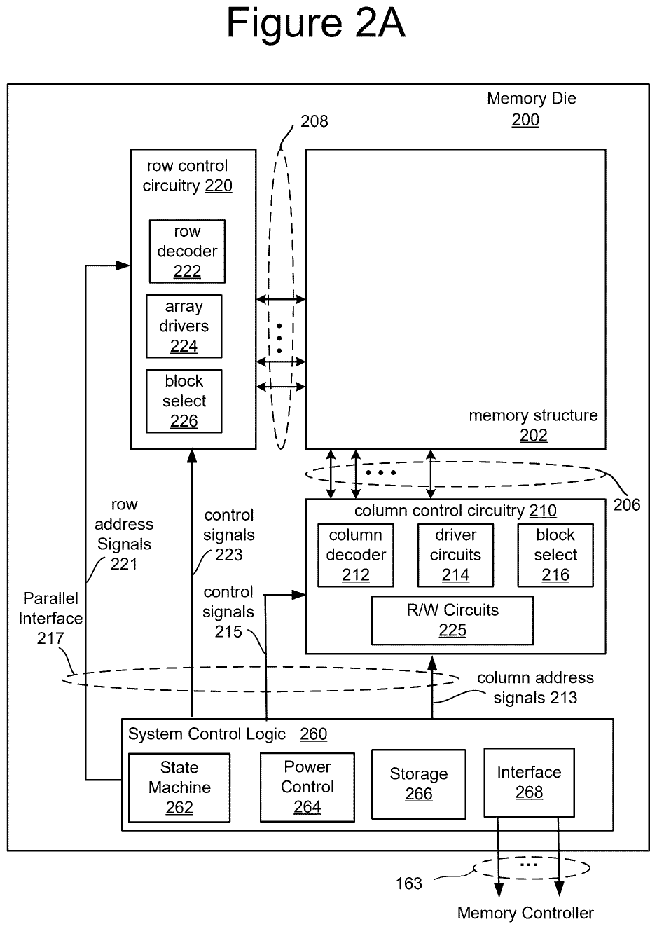

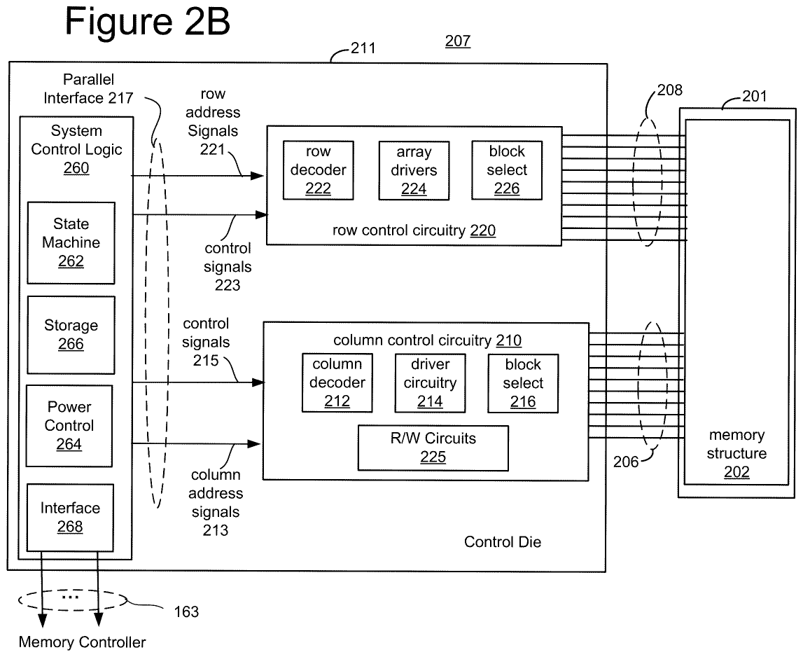

In one embodiment, nonvolatile storage 130 comprises one or more memory dies. FIG. 2A is a functional block diagram of one embodiment of a memory die 200 that comprises nonvolatile storage 130. Each of the one or more memory dies of nonvolatile storage 130 can be implemented as memory die 200 of FIG. 2A. The components depicted in FIG. 2A are electrical circuits. Memory die 200 includes a memory structure 202 (e.g., memory array) that can comprise nonvolatile memory cells (also referred to as nonvolatile storage cells), as described in more detail below. The array terminal lines of memory structure 202 include the various layer(s) of word lines organized as rows, and the various layer(s) of bit lines organized as columns. However, other orientations can also be implemented. Memory die 200 includes row control circuitry 220, whose outputs are connected to respective word lines of the memory structure 202. Row control circuitry 220 receives a group of row address signals 221 and control signals 223 from System Control Logic 260, and typically may include such circuits as row decoders 222, array drivers 224, and block select circuit 226 for both reading and writing (programming) operations. Row control circuitry 220 may also include read/write circuitry. Memory die 200 also includes column control circuitry 210 including read/write circuits 225. The read/write circuits 225 may contain sense amplifiers and data latches. The sense amplifier(s) input/outputs are connected to respective bit lines of the memory structure 202. Although only a single block is shown for memory structure 202, a memory die can include multiple arrays that can be individually accessed. Column control circuitry 210 receives column address signals 213 and control signals 215 from System Control Logic 260, and typically may include such circuits as column decoders 212, array terminal receivers or driver circuits 214, block select circuit 216, as well as read/write circuitry, and I/O multiplexers. Row address signals 221, control signals 223, column address signals 213 and control signals 215 may be sent as parallel signals from system control logic 260 to row control circuitry 220 and column control circuitry 210 (e.g., with dedicated conductive lines or traces for each control signal and/or each bit of an address information) and these parallel signals (row address signals 221, control signals 223, column address signals 213 and control signals 215) and corresponding conductors or traces may be considered a parallel interface 217 between system control logic 260 and row/column control circuitry 220/210. In addition to parallel interface 217, which is configured for communication of control signals and addresses, an additional interface (not shown) may be provided for data to be stored in memory structure 202 (e.g., write data) and data read from memory structure 202 (e.g., read data).

System control logic 260 receives data and commands from memory controller 120 via communication channel 163 and provides output data and status to the host. In some embodiments, the system control logic 260 (which comprises one or more electrical circuits) includes state machine 262 that provides die-level control of memory operations. In one embodiment, the state machine 262 is programmable by software. In other embodiments, the state machine 262 does not use software and is completely implemented in hardware (e.g., electrical circuits). In another embodiment, the state machine 262 is replaced by a micro-controller or microprocessor, either on or off the memory chip. System control logic 260 can also include a power control module 264 that controls the power and voltages supplied to the rows and columns of the memory structure 202 during memory operations. System control logic 260 includes storage 266 (e.g., RAM, registers, latches, etc.), which may be used to store parameters for operating the memory structure 202.

Commands and data are transferred between memory controller 120 and memory die 200 via communication channel 163 memory controller interface 268 (also referred to as a “communication interface”). Memory controller interface 268 is an electrical interface for communicating with memory controller 120. Examples of memory controller interface 268 include a Toggle Mode Interface and an Open NAND Flash Interface (ONFI). Other I/O interfaces can also be used.

In some embodiments, all the elements of memory die 200, including the system control logic 260, can be formed as part of a single die. In other embodiments, some or all of the system control logic 260 can be formed on a different die than the die that contains the memory structure 202.

In one embodiment, memory structure 202 comprises a three-dimensional memory array of nonvolatile memory cells in which multiple memory levels are formed above a single substrate, such as a wafer. The memory structure may comprise any type of nonvolatile memory that are monolithically formed in one or more physical levels of memory cells having an active area disposed above a silicon (or other type of) substrate. In one example, the nonvolatile memory cells comprise vertical NAND strings with charge-trapping layers.

In another embodiment, memory structure 202 comprises a two-dimensional memory array of nonvolatile memory cells. In one example, the nonvolatile memory cells are NAND flash memory cells utilizing floating gates. Other types of memory cells (e.g., NOR-type flash memory) can also be used.

The exact type of memory array architecture or memory cell included in memory structure 202 is not limited to the examples above. Many different types of memory array architectures or memory technologies can be used to form memory structure 202. No particular nonvolatile memory technology is required for purposes of the new claimed embodiments proposed herein. Other examples of suitable technologies for memory cells of the memory structure 202 include ReRAM memories (resistive random access memories), magnetoresistive memory (e.g., MRAM, Spin Transfer Torque MRAM, Spin Orbit Torque MRAM), FeRAM, phase change memory (e.g., PCM), and the like. Examples of suitable technologies for memory cell architectures of the memory structure 202 include two dimensional arrays, three dimensional arrays, cross-point arrays, stacked two dimensional arrays, vertical bit line arrays, and the like.

One example of a ReRAM cross-point memory includes reversible resistance-switching elements arranged in cross-point arrays accessed by X lines and Y lines (e.g., word lines and bit lines). In another embodiment, the memory cells may include conductive bridge memory elements. A conductive bridge memory element may also be referred to as a programmable metallization cell. A conductive bridge memory element may be used as a state change element based on the physical relocation of ions within a solid electrolyte. In some cases, a conductive bridge memory element may include two solid metal electrodes, one relatively inert (e.g., tungsten) and the other electrochemically active (e.g., silver or copper), with a thin film of the solid electrolyte between the two electrodes.

Another example is magnetoresistive random access memory (MRAM) that stores data by magnetic storage elements. The elements are formed from two ferromagnetic layers, each of which can hold a magnetization, separated by a thin insulating layer. One of the two layers is a permanent magnet set to a particular polarity; the other layer's magnetization can be changed to match that of an external field to store memory. A memory device is built from a grid of such memory cells. In one embodiment for programming, each memory cell lies between a pair of write lines arranged at right angles to each other, parallel to the cell, one above and one below the cell. When current is passed through them, an induced magnetic field is created. MRAM based memory embodiments will be discussed in more detail below.

Phase change memory (PCM) exploits the unique behavior of chalcogenide glass. One embodiment uses a GeTe—Sb2Te3 super lattice to achieve non-thermal phase changes by simply changing the co-ordination state of the Germanium atoms with a laser pulse (or light pulse from another source). Therefore, the doses of programming are laser pulses. The memory cells can be inhibited by blocking the memory cells from receiving the light. In other PCM embodiments, the memory cells are programmed by current pulses. Note that the use of “pulse” in this document does not require a square pulse but includes a (continuous or non-continuous) vibration or burst of sound, current, voltage light, or other wave. These memory elements within the individual selectable memory cells, or bits, may include a further series element that is a selector, such as an ovonic threshold switch or metal insulator substrate.

A person of ordinary skill in the art will recognize that the technology described herein is not limited to a single specific memory structure, memory construction or material composition, but covers many relevant memory structures within the spirit and scope of the technology as described herein and as understood by one of ordinary skill in the art.

The elements of FIG. 2A can be grouped into two parts: (1) memory structure 202 and (2) peripheral circuitry, which includes all of the other components depicted in FIG. 2A. An important characteristic of a memory circuit is its capacity, which can be increased by increasing the area of the memory die of storage system 100 that is given over to the memory structure 202; however, this reduces the area of the memory die available for the peripheral circuitry. This can place quite severe restrictions on these elements of the peripheral circuitry. For example, the need to fit sense amplifier circuits within the available area can be a significant restriction on sense amplifier design architectures. With respect to the system control logic 260, reduced availability of area can limit the available functionalities that can be implemented on-chip. Consequently, a basic trade-off in the design of a memory die for the storage system 100 is the amount of area to devote to the memory structure 202 and the amount of area to devote to the peripheral circuitry.

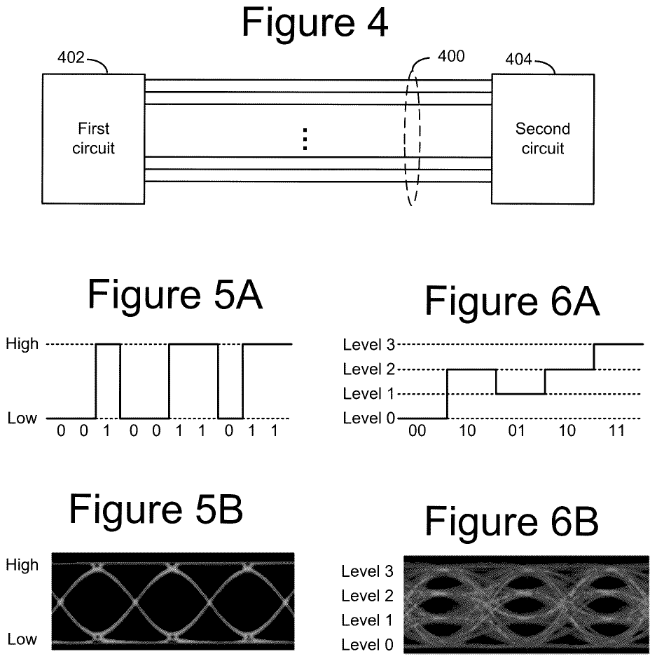

Another area in which the memory structure 202 and the peripheral circuitry are often at odds is in the processing involved in forming these regions, since these regions often involve differing processing technologies and the trade-off in having differing technologies on a single die. For example, when the memory structure 202 is NAND flash, this is an NMOS structure, while the peripheral circuitry is often CMOS based. For example, elements such sense amplifier circuits, charge pumps, logic elements in a state machine, and other peripheral circuitry in system control logic 260 often employ PMOS devices. Processing operations for manufacturing a CMOS die will differ in many aspects from the processing operations optimized for an NMOS flash NAND memory or other memory cell technologies. Three-dimensional NAND structures (see, for example, FIG. 4) in particular may benefit from specialized processing operations.

To improve upon these limitations, embodiments described below can separate the elements of FIG. 2A onto separately formed dies that are then bonded together. More specifically, the memory structure 202 can be formed on one die (referred to as the memory die) and some or all of the peripheral circuitry elements, including one or more control circuits, can be formed on a separate die (referred to as the control die). For example, a memory die can be formed of just the memory elements, such as the array of memory cells of flash NAND memory, MRAM memory, PCM memory, ReRAM memory, or other memory type. Some or all of the peripheral circuitry, even including elements such as decoders and sense amplifiers, can then be moved on to a separate control die. This allows each memory die to be optimized individually according to its technology. For example, a NAND memory die can be optimized for an NMOS based memory array structure, without worrying about the CMOS elements that have now been moved onto a control die that can be optimized for CMOS processing. This allows more space for the peripheral elements, which can now incorporate additional capabilities that could not be readily incorporated were they restricted to the margins of the same die holding the memory cell array. The two die can then be bonded together in a bonded multi-die memory circuit, with the array on the one die connected to the periphery elements on the other die. Although the following will focus on a bonded memory circuit of one memory die and one control die, other embodiments can use more die, such as two memory die and one control die, for example.

FIG. 2B shows an alternative arrangement to that of FIG. 2A which may be implemented using wafer-to-wafer bonding to provide a bonded die pair. FIG. 2B depicts a functional block diagram of one embodiment of an integrated memory assembly 207. One or more integrated memory assemblies 207 may be used to implement the nonvolatile storage 130 of storage system 100. The integrated memory assembly 207 includes two types of semiconductor dies (or more succinctly, “die”). Memory structure die 201 (memory die) includes memory structure 202. Memory structure 202 includes nonvolatile memory cells. Control die 211 includes control circuitry 260, 210, and 220 connected by parallel interface 217 (as described above). In some embodiments, control die 211 is configured to connect to the memory structure 202 in the memory structure die 201. In some embodiments, the memory structure die 201 and the control die 211 are bonded together.

FIG. 2B shows an example of the peripheral circuitry, including control circuits, formed in a peripheral circuit or control die 211 coupled to memory structure 202 formed in memory structure die 201. Common components are labelled similarly to FIG. 2A. System control logic 260, row control circuitry 220, and column control circuitry 210 are located in control die 211. In some embodiments, all or a portion of the column control circuitry 210 and all or a portion of the row control circuitry 220 are located on the memory structure die 201. In some embodiments, some of the circuitry in the system control logic 260 is located on the on the memory structure die 201. Locating components (e.g., peripheral circuits) such as system control logic 260, row control circuitry 220, and column control circuitry 210 in a separate die to memory structure 202 instead of locating such components with memory structure 202 on a common die (e.g., die memory die 200 of FIG. 2A) may have some advantages.

System control logic 260, row control circuitry 220, and column control circuitry 210 may be formed by a common process (e.g., CMOS process), so that adding elements and functionalities, such as ECC, more typically found on a memory controller 120 may require few or no additional process steps (i.e., the same process steps used to fabricate memory controller 120 may also be used to fabricate system control logic 260, row control circuitry 220, and column control circuitry 210). Thus, while moving such circuits from a die such as memory structure die 201 may reduce the number of steps needed to fabricate such a die, adding such circuits to a die such as control die 211 may not require many additional process steps. The control die 211 could also be referred to as a CMOS die, due to the use of CMOS technology to implement some or all of control circuitry 260, 210, 220.

FIG. 2B shows column control circuitry 210 including read/write circuits 225 on the control die 211 coupled to memory structure 202 on the memory structure die 201 through communication channel 206 (e.g., parallel communication channel). Similarly, row control circuitry 220, including row decoder 222, array drivers 224, and block select circuit 226 are coupled to memory structure 202 through communication channel 208 (e.g., parallel communication channel).

For purposes of this document, the phrases “a control circuit” or “one or more control circuits” can include any one of or any combination of memory controller 120, state machine 262, power control module 264, interface 268, all or a portion of system control logic 260, all or a portion of row control circuitry 220, all or a portion of column control circuitry 210, read/write circuits 225, sense amps, a microcontroller, a microprocessor, and/or other similar functioned circuits. A control circuit can include hardware only or a combination of hardware and software (including firmware). For example, a controller programmed by firmware to perform the functions described herein is one example of a control circuit. A control circuit can include a processor, FPGA, ASIC, integrated circuit, or other type of circuit.

For purposes of this document, the term “apparatus” can include, but is not limited to, one or more of, storage system 100, memory controller 120, nonvolatile storage 130, memory die 200, integrated memory assembly 207, and/or control die 211.

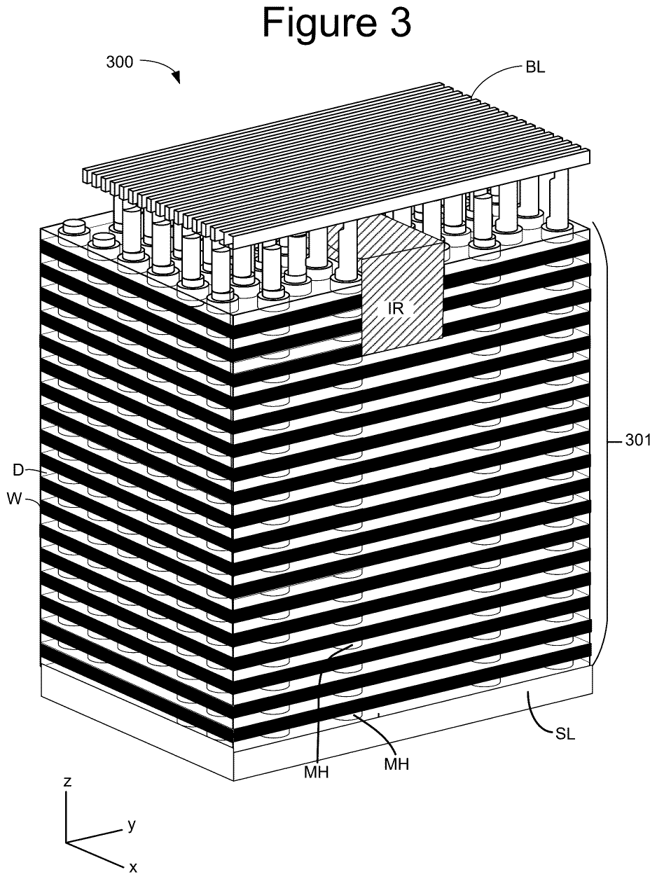

FIG. 3 is a perspective view of a portion of one example embodiment of a monolithic three dimensional memory array/structure that can comprise memory structure 202, which includes a plurality nonvolatile memory cells arranged as vertical NAND strings. For example, FIG. 3 shows a portion 300 of one block of memory. The structure depicted includes a set of bit lines BL positioned above a stack 301 of alternating dielectric layers and conductive layers. For example purposes, one of the dielectric layers is marked as D and one of the conductive layers (also called word line layers) is marked as W. The number of alternating dielectric layers and conductive layers can vary based on specific implementation requirements. In one embodiment the alternating dielectric layers and conductive layers are divided into four (or a different number of) regions (e.g., sub-blocks) by isolation regions IR. FIG. 3 shows one isolation region IR separating two sub-blocks. Below the alternating dielectric layers and word line layers is a source line layer SL. Memory holes are formed in the stack of alternating dielectric layers and conductive layers. For example, one of the memory holes is marked as MH. Note that in FIG. 3, the dielectric layers are depicted as see-through so that the reader can see the memory holes positioned in the stack of alternating dielectric layers and conductive layers. In one embodiment, NAND strings are formed by filling the memory hole with materials including a charge-trapping material to create a vertical column of memory cells. Each memory cell can store one or more bits of data. More details of the three dimensional monolithic memory array that comprises memory structure 202 is provided below.

In some examples, one or more communication channel of a system (e.g., a data storage system) may be implemented as a parallel communication channel (e.g., one or more of communication channels 103 and 163 of storage system 100). FIG. 4 shows an example of a parallel communication channel 400 between a first circuit 402 and a second circuit 404 (e.g., between memory interface 160 of memory controller 120 and interface 268 of memory die 200 or control die 211). Communication channel 400 is formed by electrically conductive connections (e.g., wires, traces, bond pads, pins and/or other electrically conductive elements) that extend in parallel. Each such conductive connection may convey an electrical signal (e.g., a voltage). The signal level at a particular time may correspond to a logic state (e.g., a particular voltage may indicate a logic state corresponding to one or more bit of data). Signals may be controlled in parallel to send a sequence of logical words. For example, the signal levels of a group of signals may be controlled to send a logical word from a source circuit (e.g., first circuit 402) in each clock cycle and receive the word at a destination circuit (e.g., second circuit 404) in each clock cycle. In addition to conductive connections that convey data signals, one or more conductive connection of parallel communication channel 400 may convey other signals such as a clock signal, a command signal or other signal. Parallel communication channel 400 may enable data transfer in both directions (e.g., from first circuit 402 to second circuit 404 and from second circuit 404 to first circuit 402).

In some examples, a signal used to convey data over a parallel communication channel may use two signal levels (e.g., two voltages or voltage ranges) to convey one bit per at a time (e.g., one bit per clock cycle per conductive connection). For example, eight conductive connections may be used to transfer a logical word that consists of eight bits (one byte) in parallel.

FIG. 5A shows an example of a signal that uses two signal levels, high and low, to transfer one bit at a time (e.g., one bit per clock cycle or per clock edge). A low signal level (e.g., zero volts, negative voltage, voltage range from −1 to 1 volts or other voltage or voltage range) corresponds to logic 0 while a high signal level (e.g., one volt, two volts, three and a half volts, five volts, positive voltage, voltage range from two to four volts or other voltage or voltage range) corresponds to logic 1. An example of a communication channel configuration using two signal levels is Non-Return-to-Zero (NRZ).

FIG. 5B shows an example of a voltage trace corresponding to the two-level signal of FIG. 5A, which illustrates transitions between signal levels over time (e.g., from clock cycle to clock cycle). FIG. 5B shows transitions between signal levels taking some time (e.g., not instantaneous as in the conceptual illustration of FIG. 5A).

FIG. 6A shows an example of a signal that uses four signal levels, level 0 to level 3 to transfer two bits at a time (e.g., two bits per clock cycle or per clock edge). The lowest signal level, level 0, corresponds to logic state 00, the second lowest signal level, level 1,corresponds to logic state 01, the second highest signal level, level 2, corresponds to logic state 10 and the highest signal level, level 3, corresponds to logic state 11. Other mappings are possible. Because the communication channel of FIG. 6A transfers two bits per signal or logic state (e.g., each logic state corresponds to two bits), the data transfer rate may be twice the rate of the communication channel of FIG. 5A. An example of a communication channel configuration using four signal levels is four-level Pulse Amplitude Modulation (PAM4).

FIG. 6B shows an example of a voltage trace corresponding to the four-level signal of FIG. 6A, which illustrates transitions between signal levels over time. It can be seen that the different signal levels are not as clearly defined as in FIG. 5B, which may result in a lower SNR and higher error rate (e.g., some signal levels may not be accurately distinguished, which may result in bad bits). For example, while FIG. 5B shows large well-defined margins between signal levels in each cycle (e.g., relatively large defined “eyes”), FIG. 6B shows much smaller and less defined eyes.

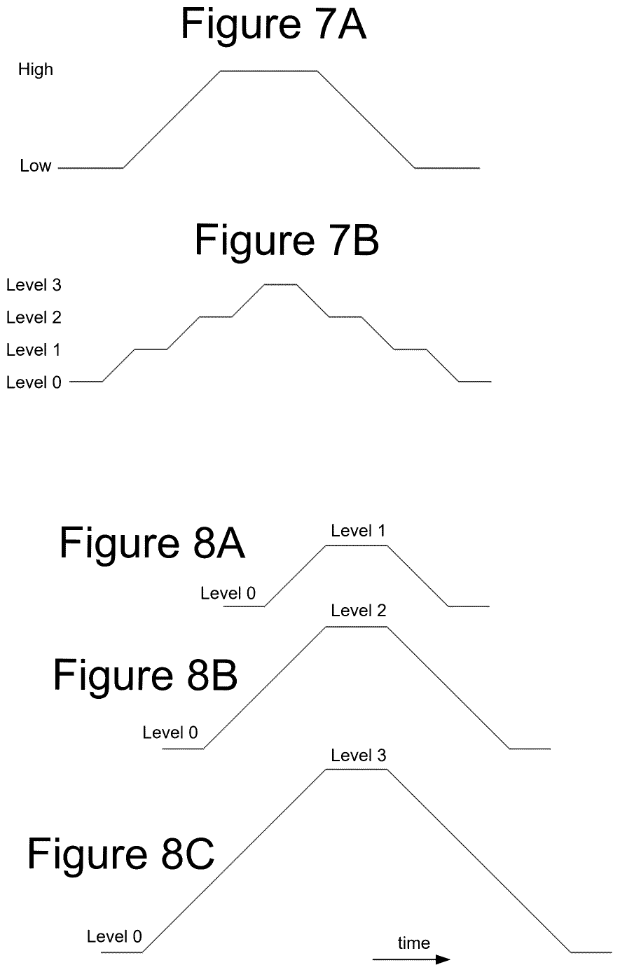

FIG. 7A illustrates an example of signal swing of a two-level signal (e.g., FIGS. 5A-B) while FIG. 7B illustrates an example of signal swing of a four-level signal (e.g., FIGS. 6A-B). It can be seen that signal swing between signal levels of the four-level signal of FIG. 7B are relatively small compared with signal swing between signal levels of the two-level signal of FIG. 7A.

FIGS. 8A-C illustrate examples of slew rate for different transitions between signal levels of a four-level signal (e.g., signal of FIGS. 6A-B) with the horizontal axis corresponding to time. It can be seen that the rise and fall time for transitions between levels 0 and 3 (e.g., from level 0 to level 3 and from level 3 to level 0) are relatively high, which may affect the accuracy of data from the channel (e.g., eye width along the time dimension may be negatively affected by transitions between these signal levels).

Aspects of the present technology are directed to reducing selected transitions between signal levels in parallel communications, which may improve signal quality (e.g., increase Signal-to-Noise Ratio (SNR)). For example, particular transitions that have a greater negative impact on SNR and/or another metric may be selected and measures may be taken to reduce occurrence of such transitions. For example, because transitions between signal levels 0 and 3 impact SNR (e.g., FIG. 8C), these transitions may be selected and data may be encoded to reduce occurrence of these transitions. In some cases, other transitions may be selected (in addition and/or alternatively).

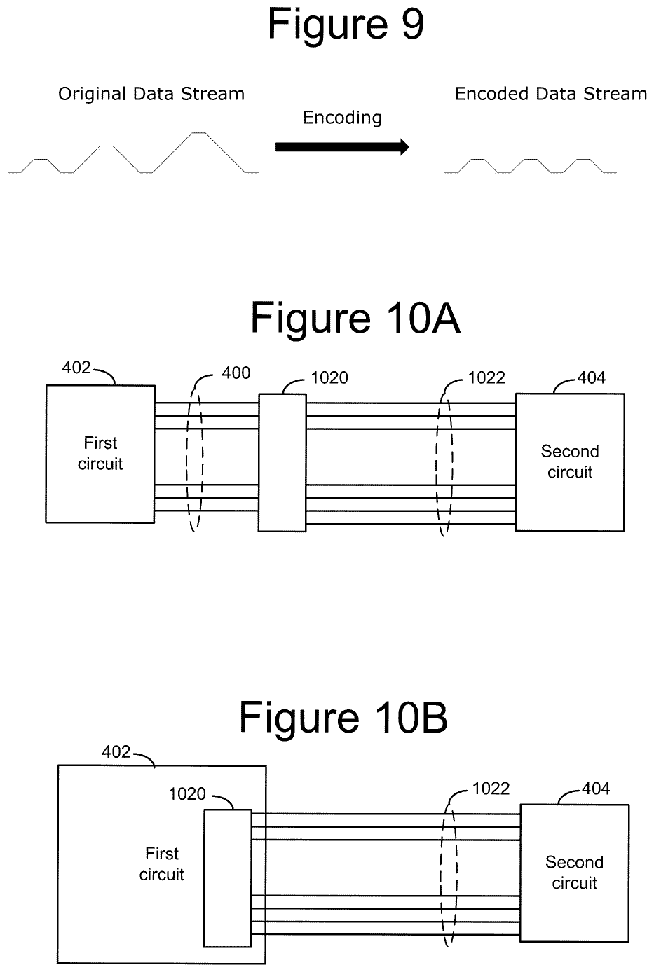

FIG. 9 provides a conceptual illustration of aspects of the present technology. A signal of an original data stream is shown on the left that includes relatively large transitions between signal levels (e.g., between signal levels 0 and 3). Encoding is used to generate a corresponding signal of an encoded data stream. The encoded data steam has fewer large transitions between signal levels. For example, one or more large transitions may be selected and reduced in number by appropriate encoding of the original data stream by appropriate encoding circuits. While it may not be possible to eliminate all selected transitions, reducing the number of such transitions may provide significant benefits (e.g., increased SNR and/or reduced BER).

While aspects of the present technology are illustrated by particular examples, the present technology is not limited to the examples provided and may be applied to any suitable communication channel used in any context. For example, the present technology may be used in systems other than data storage systems. The present technology may be applied to communication channels using any number of signal levels (e.g., more than the four signal levels of a PAM4 channel). For example, n different signal levels may be used where n may be any number that is mapped to logic states in any suitable manner (e.g., n may be a power of two so that each logic state represents an integer number of bits).

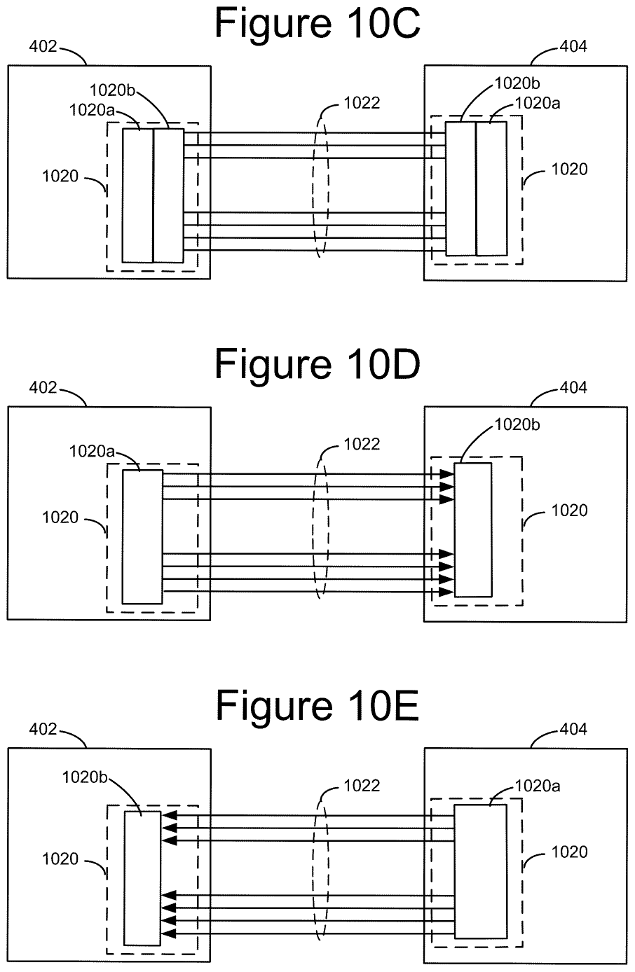

FIGS. 10A-B show examples of encoding/decoding circuit 1020 that may be used to encode and decode data that is transferred over a communication channel. For example, data may be sent by first circuit 402 over communication channel 400, which includes m conductive connections so that m different signals are provided in parallel. Communication channel 400 uses an n-level scheme (e.g., a four-level scheme as illustrated in FIGS. 6A-B so that each logic state corresponds to two bits of data). Encoding/decoding circuit 1020 is configured to receive data over communication channel 400 (e.g., as a sequence of words, with each word represented by m signals on m corresponding conductive connections). Encoding/decoding circuit 1020 encodes data to reduce selected transitions that occur between signal levels of successive words. The encoded data (encoded words) are then sent to second circuit 404 over communication channel 1022. Communication channel 1022 may include more conductive connections than communication channel 400 (e.g., one or more conductive connection may be provided to send encoding information that may enable decoding at second circuit 404). Encoding/decoding circuit 1022 may also receive encoded data from second circuit 404 via communication channel 1022 and may decode the data (e.g., using encoding information received over communication channel 1022 to reverse an encoding operation and return original data). Original data may be sent over communication channel 400 to first circuit 402.

FIG. 10B shows an alternative arrangement in which encoder/decoder circuit 1020 is implemented in first circuit 402 (e.g., in an interface circuit connected to communication channel 1022). Encoder/decoder circuit 1020 may receive data for encoding from other circuits of first circuit 402 via an internal communication channel. An encoder/decoder circuit may also be implemented in second circuit 404 so that original data is recovered in second circuit 404 and data sent from second circuit 404 over communication channel 1022 may be encoded prior to sending.

FIG. 10C shows an example that includes encoder/decoder circuit 1020 in both first circuit 402 and second circuit 404 to enable encoding prior to sending data over communication channel 1022 and decoding after receiving data via communication channel 1022 in both directions. Encoder/decoder circuit 1020 includes an encoder circuit 1020a and a decoder circuit 1020b.

For example, as shown in FIG. 10D, encoder circuit 1020a in first circuit 402 may encode data that is then sent over communication channel 1022 to second circuit 404 where it is decoded by decoder circuit 1020b of second circuit 404.

In the example of FIG. 10E encoder circuit 1020a in second circuit 404 may encode data that is then sent over communication channel 1022 to first circuit 402 where it is decoded by decoder circuit 1020b of first circuit 402.

Encoder/decoder circuit 1020 may be configured to reduce occurrence of selected transitions between words in a sequence (e.g., in a sequence of words of parallel communication). For example, encoder/decoder circuit 1020 (e.g., as shown in FIGS. 10A-B) may be configured to receive a sequence of words, where each word is represented by m signals (e.g., m voltages on m conductive connections) with each signal having a corresponding signal level (e.g., one of n signal levels or voltages) that indicates a corresponding logic state (e.g., where n=4, logic states 00, 01, 10 and 11). Encoder/decoder circuit 1020 may compare signal levels of a current word in the sequence with signal levels of a previous word that is immediately prior to the current word in the sequence (e.g., to analyze transitions between signal levels of the previous and current word) and encode the current word to reduce selected transitions between signal levels of the previous word and corresponding signal levels of the current word.

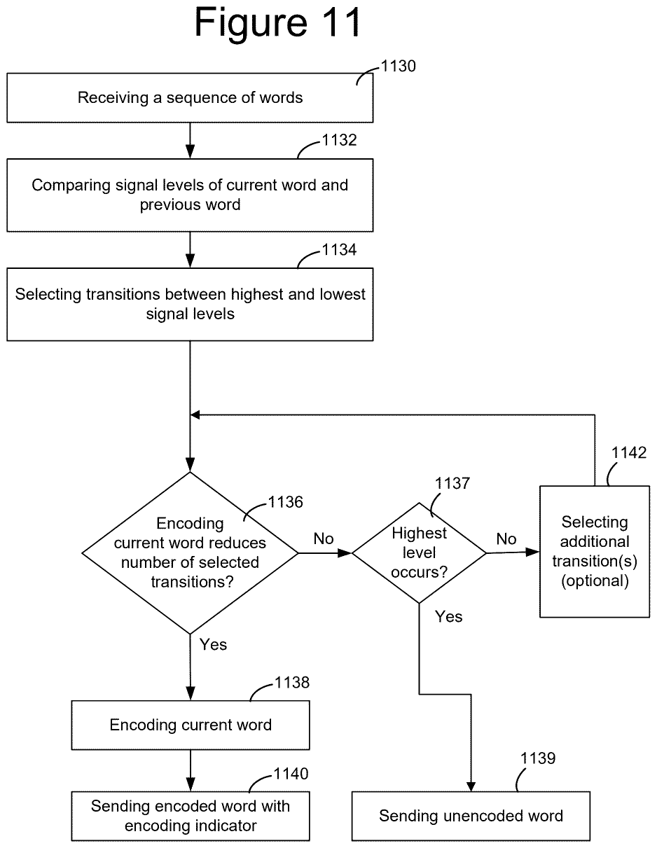

FIG. 11 shows an example of a method of encoding that may be implemented by encoding/decoding circuit 1020. The method includes receiving a sequence of words 1130, comparing signal levels of the current word and a previous word 1132 (e.g., word that is immediately prior to the current word in the sequence) and selecting transitions between the highest and lowest signal levels 1134 (e.g., selecting transitions between levels 3 and 0, including both transitions from level 3 to level 0 and from level 0 to level 3). The method further includes determining whether encoding the current word reduces the number of selected transitions 1136 (e.g., whether applying a particular encoding operation to the current word would reduce the number of selected transitions). The method also includes, when encoding the current word reduces the number of selected transitions, encoding the current word 1138 and sending the encoded word with an encoding indicator 1140 (e.g., an encoding indicator that indicates an encoding operation used to generate the encoded word). The method further includes, when encoding the current word does not reduce the number of selected transitions, determining if the highest level occurs 1137 (e.g., if highest signal level, level 3, occurs in current word or previous word) and if it does sending the unencoded word 1139. If the highest state does not occur then selecting additional transition(s) 1142 (optional). For example, the next largest transitions may be selected (e.g., between the second highest signal level and the lowest signal level). This may be repeated until some transitions are found that can be reduced by encoding.

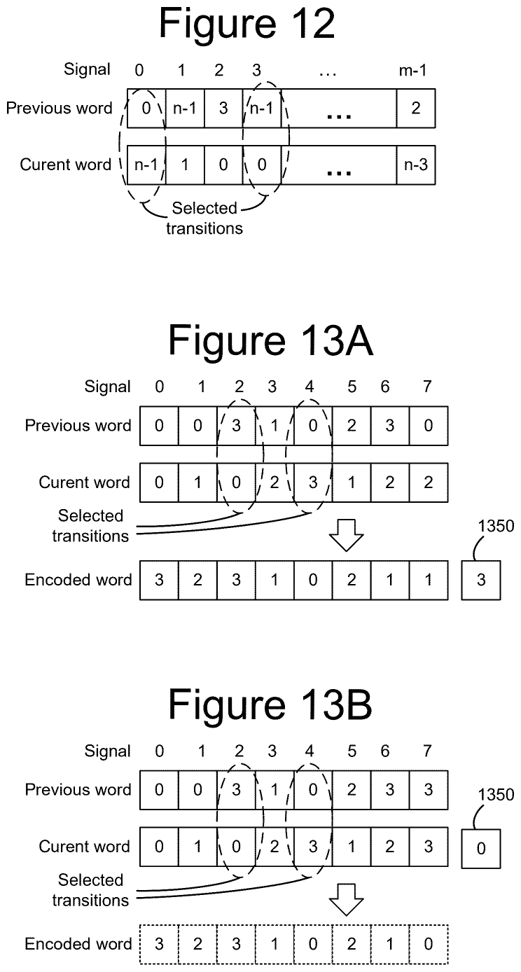

Aspects of the present technology may be applied to a wide range of communication channels that use different communication schemes. FIG. 12 illustrates an example of two sequential words in a sequence of words of a parallel communication channel. Each word may correspond to a clock cycle or clock edge. In the example of FIG. 12, m signals are provided (e.g., m conductive connections) numbered from 0 to m-1. In each word, each signal may have a signal level from n signal levels numbered from 0 to n-1. In an example, transitions between the highest and lowest signal levels may be selected first (e.g., signal 0 shows a transition from signal level 0 to signal level n-1 and signal 3 shows a transition from signal level n-1 to signal level 0). A determination may be made as to whether one or more available encoding operation would reduce the number of selected transitions. If multiple encoding operations would reduce the number of selected transitions then a suitable encoding operation may be selected (e.g., an encoding operation that provides the greatest reduction in the number of selected transitions). If no such encoding operation is available then other transitions may be selected (e.g., in descending order of magnitude of the transitions) to find an appropriate encoding operation. When an appropriate encoding operation is found, it may be applied to generate an encoded word and an encoding indicator that indicates the encoding operation used.

An encoding indicator may be in the form of one or more encoding indicator signals (e.g., on one or more dedicated encoding indicator conductive connections).

Various encoding operations may be considered at step 1136 (e.g., different encoding operations may be applied to reduce selected transitions) and an appropriate encoding operation may be applied at step 1138 to generate an encoded word and an encoding indicator that indicates the encoding operation used.

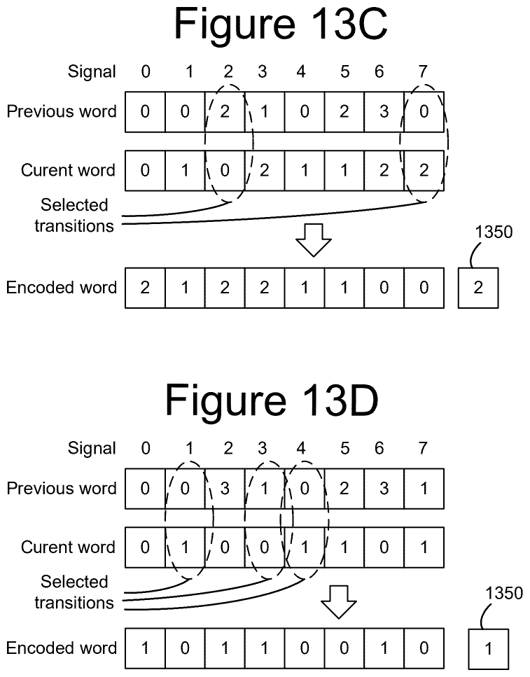

FIGS. 13A-D show examples of encoding operations for a communication channel that uses four signal levels (e.g., PAM4) to provide two bits per signal with each word corresponding to eight signals. The examples are for illustration purposes and the present technology is not limited to any number of signal levels or to any word size.

FIG. 13A shows an example of two sequential words in a sequence of words that includes two selected transitions, which in this example are transitions between the highest (level 3) and lowest (level 0) signal levels (e.g., signal 2 transitions from signal level 3 to signal level 0 while signal 4 transitions from signal level 0 to signal level 3). In this example, an available encoding operation to reduce the number of selected transitions is to subtract the signal level from 3 (e.g., more generally, subtract the signal level from n-1) for all signal levels of the current word. For example, 0 is encoded as 3 and 3 is encoded as 0 so that a transition from signal level 3 to signal level 0 (e.g., signal 2) becomes a transition from signal level 3 to signal level 3 and a transition from signal level 0 to signal level 3 (e.g., signal 4) becomes a transition from signal level 0 to signal level 0 as can be seen from the encoded word.

Because 0s and 3s are flipped in this encoding scheme (e.g., a 0 in the current word becomes a 3 in the encoded word and a 3 in the current word becomes a 0 in the encoded word) a transition from 0 to 0 or from 3 to 3 prior to encoding results in a transition between 0 and 3 after encoding. For example, signal 0 shows a transition from signal level 0 to signal level 0 prior to encoding and from signal level 0 to signal level 3 after encoding so that a selected transition is created by the encoding of signal 0. Encoding may be beneficial where encoding the current word reduces the number of selected transitions. A determination may be made as to whether an encoding operation would reduce the number of transitions or not (e.g., step 1136). For example, the number of selected transitions between the previous word and the current (unencoded) word may be compared with the number of selected transitions found between the previous word and the encoded word. In the example of FIG. 13A this may mean counting the number (first number) of selected transitions between the previous and current words (two transitions, signals 2 and 4) and the number (second number) of selected transitions that would occur between the previous and encoded word (one transition, signal 0). If the first number is greater than the second number then encoding reduces the number of selected transitions. For example, in FIG. 13 the first number (2) is greater than the second number (1) so that encoding is beneficial (reduces selected transitions from two to one).

If an encoding operation reduces selected transitions, then the current word may be encoded and sent (e.g., encoded word is sent on the communication channel instead of the current or unencoded word). In addition, an encoding indicator may be sent with the encoded word (e.g., step 1140) to indicate the encoding operation applied (e.g., so that the unencoded word can be recovered from the encoded word by reversing the operation). For example, where there are two encoding options available an encoding indicator may consist of a single bit, where there are four encoding options available an encoding indicator may consist of two bits, where there are eight encoding options available an encoding indicator may consist of three bits and so on. In the example of FIG. 13A, four encoding options are available and the encoding indicator 1350 is sent as a signal level (signal level 3 in FIG. 13A) of an encoding indicator signal (e.g., in addition to data signals of the communication channel) which may have a signal level from 0 to 3, corresponding to a two-bit encoding indicator from 00 to 11 (e.g., 00, 01, 10 and 11).

FIG. 13B shows an example which is similar to the example of FIG. 13A except that signal 7 in the previous and current word is at signal level 3 so that the transition from the previous word to the current (unencoded) word is from 3 to 3. Thus, applying the encoding operation above (encoded=n-1—unencoded or 3—unencoded) would result in two selected transitions (signals 0 and 7) which is equal to the number of transitions using the current (unencoded) word. Because encoding the current word would not reduce the number of selected transitions, the encoding operation is not implemented (e.g., the current (unencoded) word may be sent). Encoding indicator 1350 may be sent as a signal having signal level 0 (binary 00) to indicate that the current (unencoded) word is sent and that no decoding is needed to recover the unencoded word.

In some cases (e.g., where the current word does not include the highest signal level, level n-1 (signal level 3 in the above examples) and/or there is no transition between highest and lowest signal levels (e.g., between signal levels 0 and n-1 or 3)), one or more additional transitions may be selected to determine if the number of some other transition may be reduced.

FIG. 13C shows an example in which the current word does not include the highest signal level (level 3). In this case, the next largest transitions may be selected. In the example of FIG. 13C, transitions between the second highest signal level (level 2 in this example, or more generally signal level n-2) and the lowest signal level (level 0) are selected. In this example, an available encoding operation to reduce the number of selected transitions is to subtract the signal level from 2 (e.g., more generally, subtract the signal level from n-2) for all signal levels of the current word. For example, 0 is encoded as 2 and 2 is encoded as 0 so that a transition from signal level 2 to signal level 0 (e.g., signal 2) becomes a transition from signal level 2 to signal level 2 and a transition from signal level 0 to signal level 2 (e.g., signal 7) becomes a transition from signal level 0 to signal level 0 as can be seen from the encoded word.

Because the number of selected transitions (two) is greater than the combined number of transitions from 0 to 0 (one, signal 0) and from 2 to 2 (zero), encoding the current word using this encoding operation reduces the number of selected transitions. Therefore, the encoding is applied and the encoded word and encoding indicator 1350 are sent. Encoding indicator 1350 is sent by a signal level 2 (logic state 10) so that this encoding operation may be reversed to decode the encoded word.

If the second highest signal level is present in the current but encoding the current word would not reduce the selected transition, the unencoded word may be sent with an encoding indicator of signal level 0 to indicate that the word is unencoded.

FIG. 13D shows an example in which the current word does not include the highest signal level (level 3) or the second highest level (level 2). In this case, the next largest transitions may be selected. In the example of FIG. 13D, transitions between the third highest signal level (level 1 in this example, or more generally signal level n-3) and the lowest signal level (level 0) are selected. In this example, an available encoding operation to reduce the number of selected transitions is to subtract the signal level from 1 (e.g., more generally, subtract the signal level from n-3) for all signal levels of the current word. For example, 0 is encoded as 1 and 1 is encoded as 0 so that a transition from signal level 1 to signal level 0 (e.g., signal 3) becomes a transition from signal level 1 to signal level 1 and a transition from signal level 0 to signal level 1 (e.g., signals 1 and 4) becomes a transition from signal level 0 to signal level 0 as can be seen from the encoded word.

Because the number of selected transitions (three) is greater than the combined number of transitions from 0 to 0 (one, signal 0) and from 1 to 1 (one, signal 7), encoding the current word using this encoding operation reduces the number of selected transitions. Therefore, the encoding is applied and the encoded word and encoding indicator 1350 are sent. Encoding indicator 1350 is sent by a signal level 1 (binary indicator 01) so that this encoding operation may be reversed to decode the encoded word.

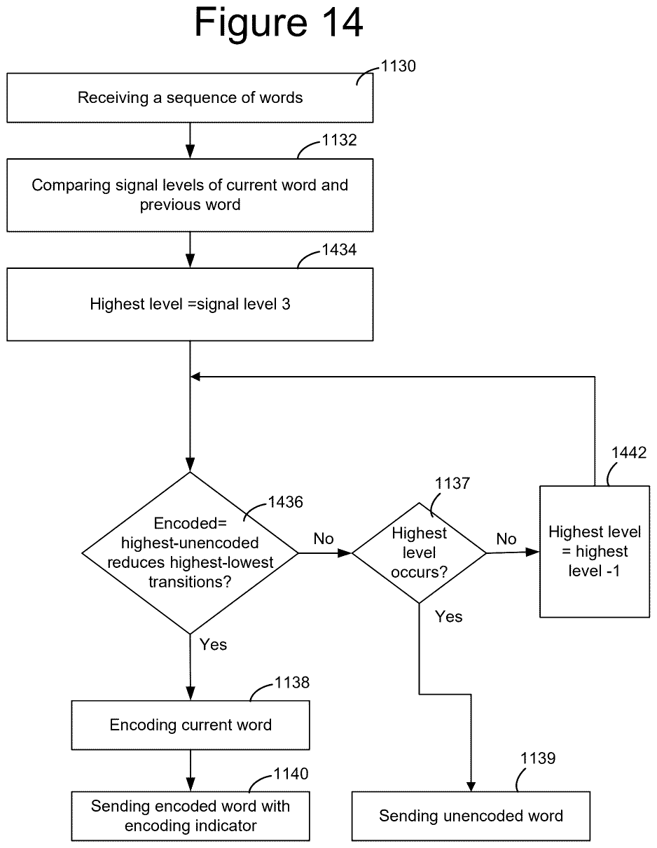

FIG. 14 illustrates an example of a method of operating an encoding circuit applied to four-level (n=4) communication channel (e.g., PAM4). The method of FIG. 14 includes steps that are similar to those of the method of FIG. 11 adapted for a four-level communication channel and may be implemented by encoding/decoding circuit 1020. The method includes receiving a sequence of words 1130, comparing signal levels of the current word and a previous word 1132 (e.g., word that is immediately prior to the current word in the sequence) and setting the highest level to signal level 3 1434. The method further includes determining whether an encoding operation that assigns an encoded signal that is equal to the highest signal level (e.g., 3) minus the unencoded signal level reduces transitions between highest and lowest signal levels (e.g., whether applying the encoding operation of FIG. 13A reduces highest-lowest transitions). The method also includes, when encoding the current word using this encoding operation reduces the number of selected transitions, encoding the current word 1138 and sending the encoded word with an encoding indicator 1140 (e.g., an encoding indicator=3 corresponding to the encoding scheme applied). The method further includes, when encoding the current word with this encoding operation does not reduce the number of highest-lowest transitions, determining if the highest level occurs 1137 (e.g., if signal level 3 occurs in current word) and if it does sending the unencoded word 1139.

If the highest state does not occur then the method (optionally) includes setting the highest level to the next highest level (highest level −1) 1442. For example, the highest level may be lowered from level 3 to level 2 and a determination may be made as to whether encoding so that the encoded signal level=2−unencoded signal level reduces highest-lowest transitions (e.g., transitions between levels 2 and 0). If encoding reduces highest-lowest transitions then the current word is encoded at step 1138 and sent with an encoding indicator 1140 (e.g., encoding indicator=2)

If this encoding does not reduce highest-lowest transitions and the highest level (level 2) does not occur, then the method (optionally) includes setting the highest level to the next highest level (highest level −1) 1442. For example, the highest level may be lowered from level 2 to level 1 and a determination may be made as to whether encoding so that the encoded signal level=(1—unencoded signal level) reduces highest-lowest transitions (e.g., transitions between levels 1 and 0). If encoding reduces highest-lowest transitions then the current word is encoded at step 1138 and sent with an encoding indicator 1140 (e.g., encoding indicator=1).

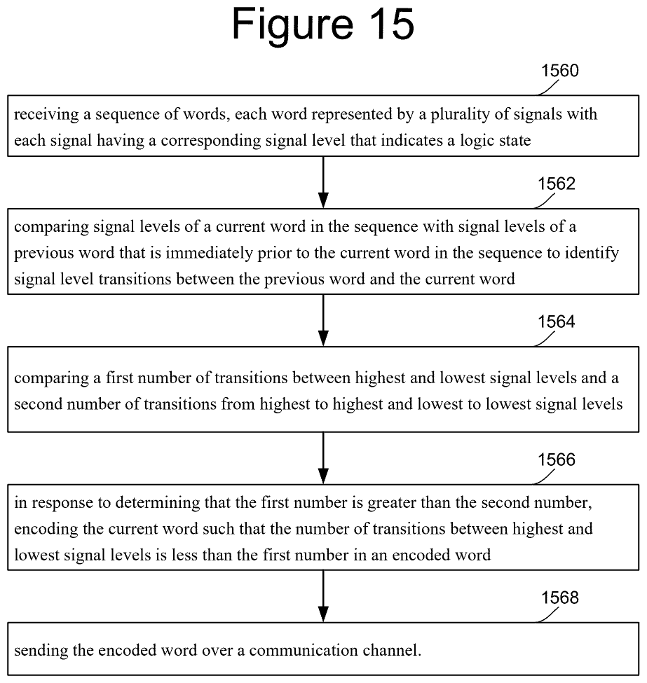

FIG. 15 shows an example of a method, which includes receiving a sequence of words, each word represented by a plurality of signals with each signal having a corresponding signal level that indicates a logic state 1560 (e.g., PAM4 signals), comparing signal levels of a current word in the sequence with signal levels of a previous word that is immediately prior to the current word in the sequence to identify signal level transitions between the previous word and the current word 1562 (e.g., as illustrated in FIGS. 13A-D) and comparing a first number of transitions between highest and lowest signal levels and a second number of transitions from highest to highest and lowest to lowest signal levels 1564. The method further includes in response to determining that the first number is greater than the second number, encoding the current word such that the number of transitions between highest and lowest signal levels is less than the first number in an encoded word 1566 and sending the encoded word over a communication channel 1568 (e.g., over PAM4 communication channel).

The methods described above, including the methods of FIGS. 14-15 may be performed by any suitable circuits. For example, encoding/decoding circuit 1020 (in memory interface 160 of memory controller 120, interface 260 of memory die 200 or control die 211 or otherwise) may perform the steps shown and may be considered an example of means for receiving a sequence of words, each word represented by a plurality of signals with each signal having a corresponding signal level that indicates a logic state, comparing signal levels of a current word in the sequence with signal levels of a previous word that is immediately prior to the current word in the sequence, encoding the current word to reduce a number of transitions between highest and lowest signal levels and sending the encoded word over the communication channel between the controller die and the memory die.

An example of an apparatus includes one or more control circuits configured to connect to a communication channel. The one or more control circuits are configured to receive a sequence of words, each word represented by a plurality of signals with each signal having a corresponding signal level that indicates a corresponding logic state. The one or more control circuits are further configured to compare signal levels of a current word in the sequence with signal levels of a previous word that is immediately prior to the current word in the sequence and encode the current word to reduce selected transitions between signal levels of the previous word and corresponding signal levels of the current word.

In one or more embodiments, the selected transitions include transitions between a highest signal level and a lowest signal level of a plurality of signal levels of the communication channel.

In one or more embodiments, the plurality of signal levels of the communication channel consists of n signal levels, the lowest signal level is level 0, the highest signal level is level n-1 and the one or more control circuits are further configured to determine a first number of transitions between levels 0 and n-1, a second number of transitions from level 0 to 0 and n-1 to n-1 and to encode the current word in response to a determination that the first number is greater than the second number.

In one or more embodiments, the one or more control circuits are configured to encode the current word by assigning signal levels of an encoded word that are equal to n-1 minus the signal levels of the current word unencoded.

In one or more embodiments, the plurality of signals of the communication channel consists of four signal levels, the lowest signal level is level 0, the highest signal level is level 3 and the one or more control circuits are configured to encode the current word by assigning signal levels of the encoded word that are equal to three minus the signal levels of the current word unencoded.

In one or more embodiments, the one or more control circuits are further configured to compare a first number of transitions from highest to lowest and lowest to highest signal levels with a second number of transitions from highest to highest and lowest to lowest signal levels and in response to a determination that the first and second numbers are equal compare transitions between additional signal levels.

In one or more embodiments, the additional signal levels include a second highest signal level of the communication channel.

In one or more embodiments, the one or more control circuit is further configured to encode the current word to reduce a number of transitions between the second highest signal level and the lowest signal level.

In one or more embodiments, the communication channel is a four-level Pulse Amplitude Modulation (PAM 4) communication channel that uses four signal levels, 0, 1, 2 and 3 and the one or more control circuits are configured to reduce a number of transitions between at least one of: levels 0 and 3, levels 0 and 2 or levels 0 and 1.

An example of a method includes receiving a sequence of words, each word represented by a plurality of signals with each signal having a corresponding signal level that indicates a logic state; comparing signal levels of a current word in the sequence with signal levels of a previous word that is immediately prior to the current word in the sequence to identify signal level transitions between the previous word and the current word; comparing a first number of transitions between highest and lowest signal levels and a second number of transitions from highest to highest and lowest to lowest signal levels; in response to determining that the first number is greater than the second number, encoding the current word such that the number of transitions between highest and lowest signal levels is less than the first number in an encoded word; and sending the encoded word over a communication channel.

In one or more embodiments, the communication channel is an n-level Pulse Amplitude Modulation (PAM) channel with signal levels 0 to n-1 and encoding the current word includes mapping each signal level of the current word to a signal level of the encoded word such that each signal level of the encoded word is n-1 minus the signal level of the current word.

In one or more embodiments, n=4 and encoding the current word includes mapping each signal level of the current word to a signal level of the encoded word such that signal level 3 is mapped to signal level 0, signal level 2 is mapped to signal level 1, signal level 1 is mapped to signal level 2 and signal level 0 is mapped to signal level 3.

In one or more embodiments, the method further includes, in response to determining for a subsequent word in the sequence of words that the first number is not greater than the second number and the subsequent word includes the highest signal level, sending the subsequent word without encoding over the communication channel.

In one or more embodiments, the method further includes, in response to determining for a subsequent word in the sequence of words that the first number is not greater than the second number and the subsequent word does not include the highest signal level, encoding the subsequent word such that the number of transitions between second highest and lowest signal levels is reduced.

In one or more embodiments, the communication channel is a four-level Pulse Amplitude Modulation (PAM 4) channel with signal levels 0 to 3 such that level 0 is the lowest signal level and level 3 is the highest signal level and encoding the subsequent word includes mapping each signal level of the subsequent word to a signal level of the encoded word that is 2 minus the signal level of the current word.

In one or more embodiments, encoding the current word includes mapping each signal level of the current word to a signal level of the encoded word such that signal level 2 is mapped to signal level 0, signal level 1 is mapped to signal level 1 and signal level 0 is mapped to signal level 2.

In one or more embodiments, the method further includes sending an encoding indicator with the encoded word over the communication channel, the encoding indicator that indicates an encoding operation used to generate the encoded word.

In one or more embodiments, the method further includes subsequently receiving the encoding indicator and the encoded word; determining the encoding operation used to generate the encoded word from the encoding indicator; and decoding the encoded word by reversing the encoding operation used to generate the encoded word as determined from the encoding indicator.

An example of a data storage system includes a memory die that includes a nonvolatile memory; a controller die; a communication channel extending between the memory die and the controller die; and means for receiving a sequence of words, each word represented by a plurality of signals with each signal having a corresponding signal level that indicates a logic state, comparing signal levels of a current word in the sequence with signal levels of a previous word that is immediately prior to the current word in the sequence, encoding the current word to reduce a number of transitions between highest and lowest signal levels and sending the encoded word over the communication channel between the controller die and the memory die.

In one or more embodiments, the communication channel is a four-level Pulse Amplitude Modulation (PAM4) communication channel.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. An apparatus comprising:
one or more control circuits configured to connect to a communication channel, the one or more control circuits are configured to:
receive a sequence of words, each word represented by a plurality of signals with each signal having a corresponding signal level that indicates a corresponding logic state, compare signal levels of a current word in the sequence with signal levels of a previous word that is immediately prior to the current word in the sequence and encode the current word to reduce selected transitions between signal levels of the previous word and corresponding signal levels of the current word.

2. The apparatus of claim 1, wherein the selected transitions include transitions between a highest signal level and a lowest signal level of a plurality of signal levels of the communication channel.

3. The apparatus of claim 2, wherein the plurality of signal levels of the communication channel consists of n signal levels, the lowest signal level is level 0, the highest signal level is level n-1 and the one or more control circuits are further configured to determine a first number of transitions between levels 0 and n-1, a second number of transitions from level 0 to 0 and n-1 to n-1 and to encode the current word in response to a determination that the first number is greater than the second number.

4. The apparatus of claim 3, wherein the one or more control circuits are configured to encode the current word by assigning signal levels of an encoded word that are equal to n-1 minus the signal levels of the current word unencoded.

5. The apparatus of claim 4, wherein the plurality of signals of the communication channel consists of four signal levels, the lowest signal level is level 0, the highest signal level is level 3 and the one or more control circuits are configured to encode the current word by assigning signal levels of the encoded word that are equal to three minus the signal levels of the current word unencoded.

6. The apparatus of claim 1, wherein the one or more control circuits are further configured to compare a first number of transitions from highest to lowest and lowest to highest signal levels with a second number of transitions from highest to highest and lowest to lowest signal levels and in response to a determination that the first and second numbers are equal compare transitions between additional signal levels.

7. The apparatus of claim 6, wherein the additional signal levels include a second highest signal level of the communication channel.

8. The apparatus of claim 7, wherein the one or more control circuit is further configured to encode the current word to reduce a number of transitions between the second highest signal level and the lowest signal level.

9. The apparatus of claim 1, wherein the communication channel is a four-level Pulse Amplitude Modulation (PAM4) communication channel that uses four signal levels, 0, 1, 2 and 3 and the one or more control circuits are configured to reduce a number of transitions between at least one of: levels 0 and 3, levels 0 and 2 or levels 0 and 1.

10. A method comprising:
receiving a sequence of words, each word represented by a plurality of signals with each signal having a corresponding signal level that indicates a logic state;
comparing signal levels of a current word in the sequence with signal levels of a previous word that is immediately prior to the current word in the sequence to identify signal level transitions between the previous word and the current word;
comparing a first number of transitions between highest and lowest signal levels and a second number of transitions from highest to highest and lowest to lowest signal levels;
in response to determining that the first number is greater than the second number, encoding the current word such that the number of transitions between highest and lowest signal levels is less than the first number in an encoded word; and
sending the encoded word over a communication channel.

11. The method of claim 10, wherein the communication channel is an n-level Pulse Amplitude Modulation (PAM) channel with signal levels 0 to n-1 and encoding the current word includes mapping each signal level of the current word to a signal level of the encoded word such that each signal level of the encoded word is n-1 minus the signal level of the current word.

12. The method of claim 11, wherein n=4 and encoding the current word includes mapping each signal level of the current word to a signal level of the encoded word such that signal level 3 is mapped to signal level 0, signal level 2 is mapped to signal level 1, signal level 1 is mapped to signal level 2 and signal level 0 is mapped to signal level 3.

13. The method of claim 10, further comprising:
in response to determining for a subsequent word in the sequence of words that the first number is not greater than the second number and the subsequent word includes the highest signal level, sending the subsequent word without encoding over the communication channel.

14. The method of claim 10, further comprising:
in response to determining for a subsequent word in the sequence of words that the first number is not greater than the second number and the subsequent word does not include the highest signal level, encoding the subsequent word such that the number of transitions between second highest and lowest signal levels is reduced.

15. The method of claim 14, wherein the communication channel is a four-level Pulse Amplitude Modulation (PAM4) channel with signal levels 0 to 3 such that level 0 is the lowest signal level and level 3 is the highest signal level and encoding the subsequent word includes mapping each signal level of the subsequent word to a signal level of the encoded word that is 2 minus the signal level of the current word.

16. The method of claim 15, wherein encoding the current word includes mapping each signal level of the current word to a signal level of the encoded word such that signal level 2 is mapped to signal level 0, signal level 1 is mapped to signal level 1 and signal level 0 is mapped to signal level 2.

17. The method of claim 10, further comprising sending an encoding indicator with the encoded word over the communication channel, the encoding indicator that indicates an encoding operation used to generate the encoded word.

18. The method of claim 17, further comprising;
subsequently receiving the encoding indicator and the encoded word;
determining the encoding operation used to generate the encoded word from the encoding indicator; and
decoding the encoded word by reversing the encoding operation used to generate the encoded word as determined from the encoding indicator.

19. A data storage system comprising:
a memory die that includes a nonvolatile memory;
a controller die;
a communication channel extending between the memory die and the controller die; and
means for receiving a sequence of words, each word represented by a plurality of signals with each signal having a corresponding signal level that indicates a logic state, comparing signal levels of a current word in the sequence with signal levels of a previous word that is immediately prior to the current word in the sequence, encoding the current word to reduce a number of transitions between highest and lowest signal levels and sending the encoded word over the communication channel between the controller die and the memory die.

20. The data storage system of claim 19, wherein the communication channel is a four-level Pulse Amplitude Modulation (PAM4) communication channel.
